(19) United States
(12) Patent Application Publication
(10) Pub. No.: US 2013/0036923 A1
(43) Pub. Date: Feb. 14, 2013

(54) Separator and Components Thereof

(71) Applicants: Michael G. Faram, Bristol (GB); Lorne B. Martin, Norfolk (GB)

(72) Inventors: Michael G. Faram, Bristol (GB); Lorne B. Martin, Norfolk (GB)

(21) Appl. No.: 13/579,244

(22) PCT Filed: Feb. 11, 2011
(86) PCT No.: PCT/GB2011/050264

§ 371 Date: Oct. 24, 2012

(30) Foreign Application Priority Data
Feb. 16, 2010 (GB) 1002621.9

(51) Int. Cl. B60B 9/12

(52) U.S. Cl. 100/37; 100/110

(57) ABSTRACT

A separator, such as a sludge compactor, comprising a perforated tubular screen, an inlet for mixture to be separated opening into the interior of the screen, a solids outlet situated at one end of the screen, and an auger disposed within the tubular screen for conveying solids retained by the screen from the inlet to the solids outlet, wherein at least one delivery device is provided for delivering washing fluid into the interior of the tubular screen.

### TECHNICAL FIELD

This invention relates to a separator and components thereof, in particular, a separator for separating solids from a fluid.

### BACKGROUND OF THE INVENTION

Separators which both separate solid material from waste water and compact the solid material for disposal are well-known. Such separators may be used, for example, to remove solids from a flow of sewage so that the water from the sewage can proceed to further treatment prior to discharge or reuse. The separated solids may be disposed of in landfill. An example of such a separator is the sludge compacting device shown in FIG. 1. The sludge compacting device 2 comprises a perforated tubular screen 4, 6 having an inlet 8 at one end and a solids outlet 10 at the other end. The screen 4, 6 is disposed within a separation chamber 12, 14 provided with a fluids outlet 16 in the lower portion of the separation chamber 12, 14. The screen 4, 6 comprises a frusto-conical section 4 towards the inlet end of the screen and a cylindrical section 6 towards the solids outlet end. The frusto-conical section 4 tapers radially inwardly from the inlet end towards the cylindrical section 6. The frusto-conical section 4 is associated with a screening zone and the cylindrical section 6 is associated with a pressing zone. An auger 34 extends along the interior of the tubular screen 4, 6 and has a profile which corresponds to the profile of the screen 4, 6. A retention cone 52 is disposed at the solids outlet 10 to obstruct flow through the solids outlet 10. The retention cone 52 is adjustably biased by pneumatic cylinders in the axial direction to control the size of the annular aperture formed between the cone 52 and the cylindrical section 6 of the screen. An outlet chamber 22 is provided adjacent the solids outlet 10 for housing the retention cone 52 and for receiving solids passing through the solids outlet 10, for discharge through an opening 24 for treatment or disposal.

In use, a sludge comprising a fluid and a solid is fed into the inlet 8. The sludge is conveyed by the auger 34 from the inlet 8 towards the solids outlet 10. As the sludge is conveyed along the screen 4, 6 the fluid flows through the perforations in the screen 4, 6 into the radially outer region of the separation chamber 12, 14. The fluid is then discharged from the outer region of the separation chamber 12, 14 through the fluids outlet 16. The solid particles which cannot pass through the screen 4, 6 are conveyed by the auger 34 along the cylindrical section 6 of the screen until they are obstructed by the retention cone 52. Obstruction by the cone 52 causes the solids to build up on the face of the cone 52 and compact to form a plug (P) which is compressed by the auger 34 to extract further liquid. The pressure applied by the auger 34 to the cone 52 causes the cone 52 to be displaced away from the screen 4, 6 to open, or increase the size of, the annular aperture to permit passage of the plug (P). Solids which pass through the outlet 10 are discharged from the separator through the outlet chamber 22.

A problem associated with this separator, and similar separators, is that the cleanliness of the discharged solids is often unacceptable: for example, when such a separator is used to process biological material the quantity of faecal content in the discharged solids is excessive, and so is not acceptable for landfill.

### SUMMARY OF THE INVENTION

According to a first aspect of the present invention there is provided a separator comprising a perforated tubular screen, an inlet for mixture to be separated opening into the interior of the screen, a solids outlet situated at one end of the screen, and an auger disposed within the tubular screen for conveying solids retained by the screen from the inlet to the solids outlet, the auger having a shaft provided with a flight, wherein delivery devices are provided at a surface of the shaft and are arranged in a spiral about the shaft for delivering washing fluid into the interior of the tubular screen.

In operation of a separator in accordance with the present invention, the washing fluid penetrates the solids and is subsequently discharged through the screen with the separated fluid from the mixture. Consequently, the solids are washed by the washing fluid and emerge in a relatively clean condition.

The shaft may be provided with a passage for conveying the washing fluid to at least one of the delivery devices. At least one delivery device may be provided at a surface of the flight.

At least one delivery device may be provided on the tubular screen. The screen may be disposed within an outer casing, in which case at least one delivery device may be provided on the outer casing and directed towards the screen.

At least one of the delivery devices may be disposed to discharge fluid in a radial direction, a direction which is tangential to the auger or in an axial direction. A delivery device or at least one of the delivery devices disposed to discharge fluid in the axial direction may be disposed to eject fluid towards the inlet.

The flight of the auger may be provided with slots or apertures to allow washing fluid to flow across the flight.

The auger may be provided with agitators. The agitators may be in the form of baffles or paddles which extend along a portion of the auger or in the form of pegs. The agitators may be provided along a portion of the auger not having a flight. The portion of the screen surrounding the agitators may be non-permeable so as to prevent flow of fluid from the interior of the screen to the exterior of the screen in the vicinity of the agitators.

The separator may be disposed within a chamber for collecting the separated fluid, the chamber being provided with a fluid outlet for discharging the separated fluid from the chamber. Means may be provided to supply the discharged separated fluid as the washing fluid to at least one of the delivery devices.

According to another aspect of the present invention, there is provided an auger for a separator according to the first aspect of the invention in which the auger has a shaft provided with a passage for conveying a washing fluid to at least one of the delivery devices provided at a surface of the auger.

According to a further aspect of the present invention there is provided a tubular screen for a separator according to the first aspect of the invention in which the tubular screen is provided with at least one delivery device for delivering a washing fluid into the interior of the tubular screen.

According to a further aspect of the invention, there is provided a method of separating solids from a mixture using a separator according to the first aspect of the invention, in which a washing fluid is supplied through the delivery device or at least one of the delivery devices into the interior of the screen. The washing fluid may be hotter than the mixture, and may comprise an additive such as a detergent, biocide, coagulant or combination thereof.

For a better understanding of the present invention and to show more clearly how it may be carried into effect, reference will now be made, by way of example, to the accompanying drawings, in which:

### BRIEF DESCRIPTION OF THE DRAWINGS

FIG. 1 shows a known separator;

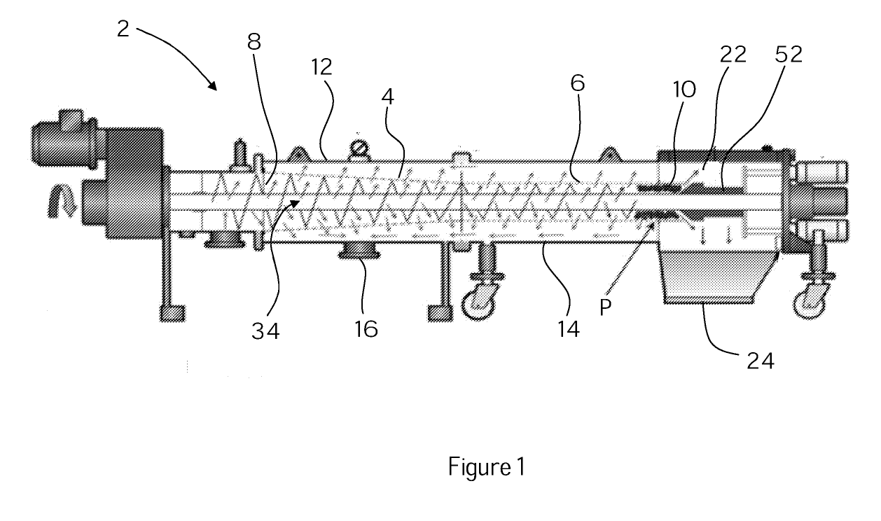

FIG. 2 shows a separator in accordance with the present invention;

FIG. 3 is a perspective view of a portion of an auger of the separator shown in FIG. 2;

FIG. 4 is a partial sectional view of a variant of the separator shown in FIG. 2;

FIG. 5 shows a further variant of the separator shown in FIG. 2; and

FIG. 6 shows a sectional view of the separator taken on the line X-X in FIG. 5.

### DETAILED DESCRIPTION OF THE DRAWINGS

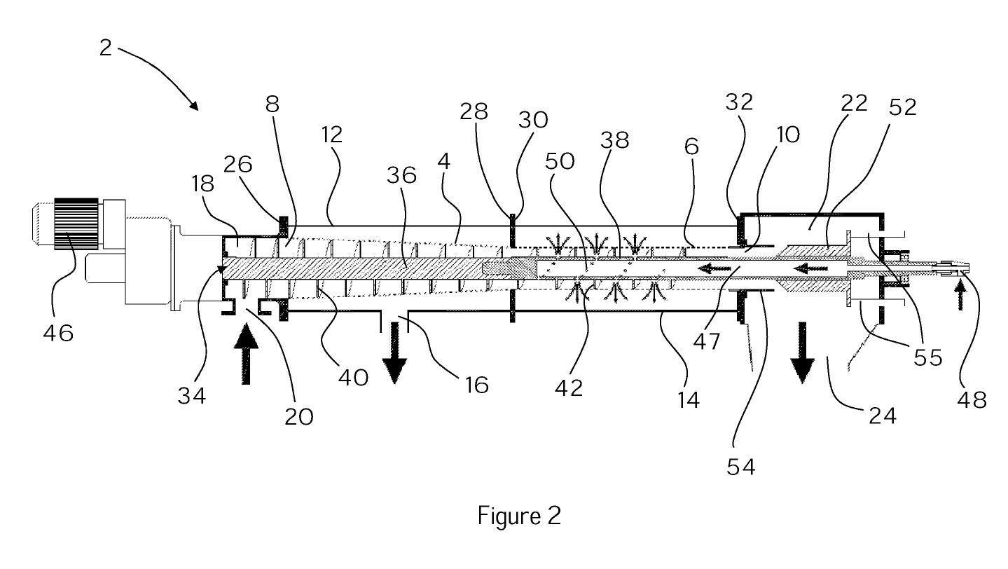

FIG. 2 shows a separator 2 comprising a perforated tubular screen 4, 6 having an inlet 8 at one end and a solids outlet 10 at the other. The tubular screen 4, 6 is disposed within a cylindrical separation chamber 12, 14 such that an annular region is created between the screen 4, 6 and the outer wall of the separation chamber 12, 14. The interior of the screen 4, 6 is in communication with the annular region through the perforations in the screen 4, 6. A fluids outlet 16 is provided in the lower region of the outer wall of the separation chamber 12, 14.

The inlet 8 opens through an end wall of the separation chamber 12, 14 into an inlet chamber 18. The inlet chamber 18 is provided with an inlet port 20 for an inflowing mixture. The solids outlet 10 opens through the other end wall of the separation chamber 12, 14 into an outlet chamber 22. The outlet chamber 22 is provided with an outlet port 24 through which solids may be discharged.

The screen 4, 6 comprises two sections: a frusto-conical section 4 and a cylindrical section 6. The frusto-conical section 4 tapers radially inwardly away from the inlet 8 towards the cylindrical section 6. The diameter of the frusto-conical section 4 adjacent the cylindrical section 6 corresponds to the diameter of the cylindrical section 6. The frusto-conical section 4 and the cylindrical section 6 are separable.

An auger 34 is disposed within the tubular screen 4, 6 and extends along the entire length of the separator 2. The auger 34 is supported for rotation at each end by bearings, and driven by a motor 46 disposed adjacent the inlet chamber 18.

The auger 34 comprises two sections: a first section comprising a first shaft 36 and a first flight 40, and a second section comprising a second shaft 38 and a second flight 42. The second shaft 38 is dowelled with the first shaft 36 so that the two shafts 36, 38 are aligned and rotate together. The first and second shafts 36, 38 are separable from each other. The flights 40, 42 are helical and arranged so as to form a continuous flight which extends through the inlet chamber 16 and through a substantial portion of the screen 4, 6.

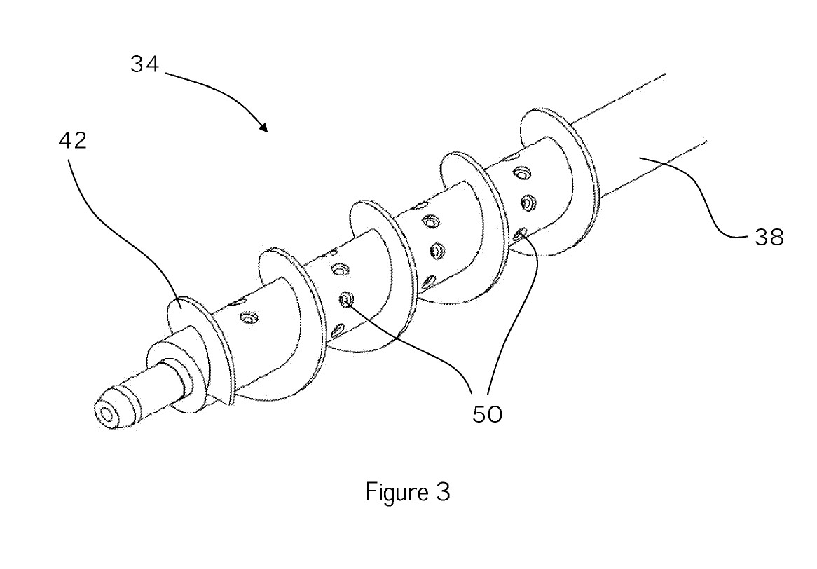

The second shaft 38 is hollow and so provides a longitudinal passage 47 which has a shaft inlet 48 provided at the end supported by the bearing. The shaft inlet 48 enables a washing fluid to be supplied to the passage 47. A plurality of holes 50 fitted with nozzles (not shown) extend through the cylindrical wall of the second shaft 38, through which the washing fluid is ejected into the interior of the cylindrical screen section 6. In this instance, the second shaft 38 is a hollow tube so that the passage 47 comprises the interior of the tube; however, it will be appreciated that any suitable conduit between the shaft inlet 48 and the nozzles 50 could be provided. FIG. 3 shows the holes 50 arranged along the surface of the second shaft 38 in a spiral which corresponds with, but is offset from, the spiral formed by the second flight 42.

Referring to FIG. 2, a frusto-conical retention cone 52 is provided at the solids outlet 10 to obstruct flow through the solids outlet 10. The retention cone 52 cooperates with a solid-walled extension 54 of the screen 4, 6 which extends into the outlet chamber 22. The retention cone 52 is movable in the axial direction with respect to the solid-walled extension 54 and is biased towards the extension 54 by pneumatic cylinders acting on piston rods 55. The pressure applied by the pneumatic cylinders may be varied.

The separation chamber 12, 14 comprises a first section 12 and a second section 14. The first and second sections 12, 14 are provided with flanges 26, 28 and 30, 32 respectively. The first and second sections 12, 14 are secured to each other, and to the inlet and outlet chambers 16, 20, by bolts passing through the flanges 26, 28, 30, 32 or other releasable joining mechanism. The separator is thus separable into a first section comprising the first shaft 36 and the frusto-conical section of the screen 4 and a second section comprising the second shaft 38 and the cylindrical section of the screen 6.

In use, a sludge, for example sewage sludge, comprising a mixture of solids and a fluid such as water is fed through the inlet port 20 into the inlet chamber 18. Rotation of the auger 34 with respect to the screen 4, 6 draws the sludge from the inlet chamber 18 along the inside of the screen 4, 6. The frusto-conical section of the screen 4 constitutes a screening zone. As the sludge is conveyed along the frusto-conical section of the screen 4, water is expelled from the sludge through the screen perforations. Water which passes through the screen perforations collects in the bottom of the separation chamber 12, 14 from where it is discharged through the fluids outlet 16. This discharged fluid may be subject to further treatment.

The auger 34 forces the remaining relatively dewatered sludge along the cylindrical section 6 of the screen towards the solids outlet 10. The cylindrical section 6 constitutes a pressing zone. As the sludge is conveyed along the cylindrical section 6, a washing fluid is supplied through the shaft inlet 48 and along the passage 47 to be delivered through the nozzles in the holes 50 into the interior of the cylindrical section 6. The washing fluid penetrates into the sludge and so agitates the sludge. Some components of the sludge, such as liquid or semi liquid faecal matter, are dislodged from the particles of the sludge and so are flushed out or diluted. In some embodiments, the water discharged through the fluids outlet 16 may be used as the washing fluid, but alternatively, clean water (for example mains water) may be used. In some circumstances, the washing fluid may include additives such as detergents, biocides or coagulants. The washing fluid may be heated, for example to assist in the flushing of fat, oil and grease from the sludge particles, the screening elements 4, 6 and perforations and the separator 2 as a whole.

The retention cone 52 obstructs flow through the solids outlet 10 thereby causing the solids to build-up and press against the face of the retention cone 52. This further expels fluid, including the washing fluid introduced during the cleaning process, through the screen perforations, and also compacts the solids. As the pressure of the accumulated solids increases, the retention cone 52 is displaced against the bias of the pneumatic cylinders to allow the compacted solids to pass between the retention cone 52 and the solid-walled screen extension 54 so as to be discharged from the outlet chamber 22 through the outlet port 24. The solids may be subject to further processing.

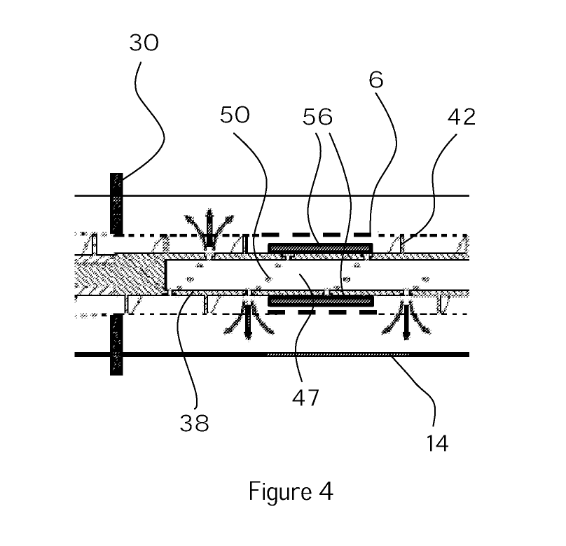

FIG. 4 shows a variant in which the separator includes a mixing zone between the screening and pressing zones. A portion of the auger flight on the second shaft 38 is replaced by agitators 56 in the form of baffles. In this variant, the baffles 56 are circumferentially spaced apart and extend along the second shaft 38 in an axial direction. The baffles 56 extend radially outwardly from the second shaft 38 and terminate at or short of the cylindrical section 6. In operation, the baffles 56 agitate the mixture thereby improving the washing effect of the washing fluid. As an alternative to the baffles 56, alternative forms of agitator may be used, for example pegs. The baffles, or alternative forms of agitator, may be situated within a portion of the screen 4, 6 which is non-permeable, i.e. does not have perforations, in order to retain water in the sludge as it is agitated.

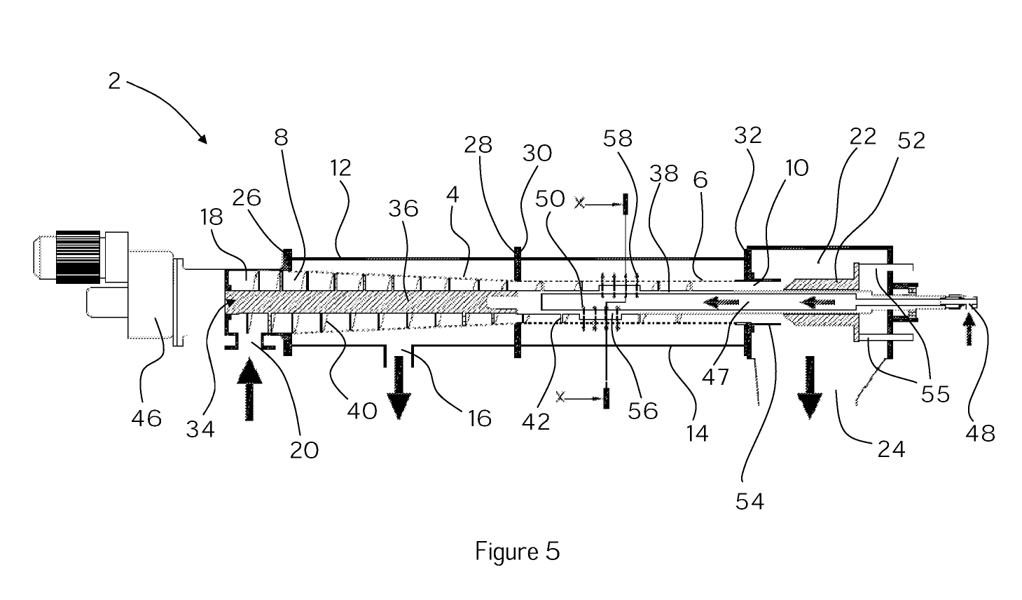

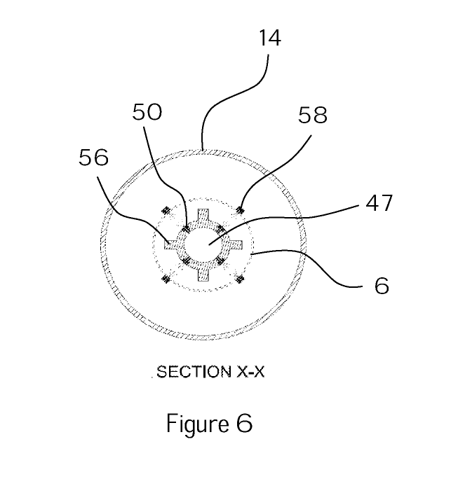

FIGS. 5 and 6 show a further variant in which part of the second flight 42 in the region of the nozzles 50 has been replaced by baffles 56, similar to those shown in FIG. 4, which extend along the second shaft 38 in an axial direction. In this variant, baffles 56 that are diametrically opposite one another are offset with respect to one another in an axial direction. In addition to the nozzles in the holes 50 provided on the second shaft 38, further nozzles 58 are provided along the radially outer wall of the screen cylindrical portion 6. These nozzles 58 are directed radially inwardly towards the shaft 38.

Although not shown, it is also possible for nozzles to be provided on the wall if the separation chamber 12, 14 directed to eject washing fluid into the accumulated solids through the perforations of the cylindrical section 6.

In the embodiments shown in the drawings, the nozzles are oriented to eject the washing fluid in a generally radial direction (inwardly or outwardly). In alternative embodiments, the nozzles may be oriented differently for example to direct the washing fluid with an axial or tangential component. In one embodiment, the shaft 36, 38 may have a radial projection supporting a nozzle oriented to direct the washing fluid in an axial direction, possibly in the upstream direction with respect to the movement of sludge through the separator.

Although the embodiments shown in the drawings have nozzles for washing fluid in the pressing zone of the separator, such nozzles may alternatively, or additionally, be provided in the screening zone. The washing fluid supply may be introduced to the auger 34 at the end nearer the motor 46, rather than the end nearer the retention cone 52, as shown.

The flight 40 of the auger 34 may be interrupted along its length, for example, by slots or apertures to enable introduced washing fluid to migrate through the sludge in the upstream direction.

The holes 50 for the nozzles are shown in the drawings in a spiral arrangement along the shaft 38. They may be disposed in different ways, for example in a circumferential array between separate sections of the auger 34 or the flight 40, 42, or in a linear array.

1. A sludge compactor comprising a perforated tubular screen, an inlet for mixture to be separated opening into the interior of the screen, a solids outlet situated at one end of the screen, a retention cone disposed at the solids outlet and arranged to obstruct flow through the solids outlet, and an auger disposed within the tubular screen for conveying solids retained by the screen from the inlet to the solids outlet, the auger having a shaft provided with a flight, wherein washing fluid delivery devices are provided at a surface of the shaft and are arranged in a spiral about the shaft for delivering washing fluid into the interior of the tubular screen, the flight of the auger being provided with slots or apertures which are arranged such that, in use, washing fluid flows through the slots or apertures across the flight.

2. A sludge compactor according to claim 1, in which the shaft is provided with a passage for conveying the washing fluid to at least one of the delivery devices.

3. A sludge compactor according to claim 1, in which at least one delivery device is provided at a surface of the flight.

4. A sludge compactor according to claim 1, in which at least one delivery device is provided on the tubular screen.

5. A sludge compactor according to claim 1, in which the screen is disposed within an outer casing, and at least one delivery device is provided on the outer casing and directed towards the screen.

6. A sludge compactor according to claim 1, in which at least one of the delivery devices is disposed to discharge fluid in a radial direction.

7. A sludge compactor according to claim 1, in which at least one of the delivery devices is disposed to discharge fluid in a direction which is tangential to the auger.

8. A sludge compactor according to claim 1, in which at least one of the delivery devices is disposed to discharge fluid in an axial direction.

9. A sludge compactor according to claim 8, in which the delivery device, or at least one of the delivery devices disposed to discharge fluid in the axial direction, is disposed to eject fluid towards the inlet.

10. A sludge compactor according to claim 1, in which the auger is provided with agitators.

11. A sludge compactor according to claim 10, in which the agitators are provided along a portion of the auger not having a flight.

12. A sludge compactor according to claim 10, in which the portion of the screen surrounding the agitators is non-permeable, said portion of the screen being arranged to prevent flow of fluid from the interior of the screen to the exterior of the screen in the vicinity of the agitators.

13. A sludge compactor according to claim 1, in which the separator is disposed within a chamber for collecting the separated fluid and in which the chamber is provided with a fluid outlet for discharging the separated fluid from the chamber.

14. A sludge compactor according to claim 13, in which means is provided to supply the discharged fluid as the washing fluid to at least one of the delivery devices.

15. (canceled)

16. An auger for a sludge compactor according to claim 1, in which the auger has a passage for conveying a washing fluid to at least one of the delivery devices provided at a surface of the auger, wherein the flight of the auger is provided with slots or apertures which are arranged such that, in use, washing fluid flows through the slots or apertures across the flight.

17. A method of separating solids from a mixture using a sludge compactor according to claim 1, in which a washing fluid is supplied through at least one of the delivery devices into the interior of the screen.

18. A method according to claim 17, in which the washing fluid is supplied at a temperature which is higher than the temperature of the mixture.

19. A method according to claim 17, in which the washing fluid comprises an additive.

20. A method according to claim 19, in which the additive is a detergent, biocide, coagulant or combination thereof
